(19) United States
(12) Patent Application Publication
(10) Pub. No.: US 2014/0368919 A1
(43) Pub. Date: Dec. 18, 2014

(54) LENS ASSEMBLY AND BAFFLE THEREOF

(71) Applicants: Sintai Optical (Shenzhen) Co., Ltd, Shenzhen City (CN); Asia Optical International Ltd., Tortola (GB)

(72) Inventor: De-Lun Liu, Taichung (TW)

(73) Assignees: Asia Optical International Ltd., Tortola (GB); Sintai Optical (Shenzhen) Co., Ltd., Shenzhen City (CN)

(21) Appl. No.: 14/306,626

(22) Filed: Jun. 17, 2014

(30) Foreign Application Priority Data
Jun. 18, 2013 (TW) 102121496

(51) Int. Cl. G02B 27/00

(52) U.S. Cl. CPC G02B 27/0018
USPC 359/611; 359/601

(57) ABSTRACT

A lens assembly and a baffle thereof are provided. The baffle includes an annular body and a plurality of protrusions. The annular body includes an annular main body, an outer ring and an inner ring. The annular main body connects the outer ring and the inner ring. The annular main body is disposed between the outer ring and the inner ring. The protrusions protrude from the outer ring. The lens assembly includes a first lens and a baffle, all of which are arranged in sequence from an object side to an image side along an optical axis. The first lens includes a first surface facing the object side and a second surface facing the image side.

### RELATED APPLICATION

This application claims the benefit of foreign priority to Taiwan Invention Patent Application No. TW102121496, filed on Jun. 18, 2013, the entire contents of which are incorporated herein by reference for all purposes.

### BACKGROUND OF THE INVENTION

1. Field of the Invention

The invention relates to a lens assembly and a baffle thereof.

2. Description of the Related Art

Referring to FIG. 1, the lens 12 of a lens assembly 10 closest to the image side has a press ring 14 disposed on an image-side surface 122 to block entry of strong light and avoid flare problem. However, the press ring 14, made by plastic injection, is usually rounded on the edges thereof so that the flare problem is worse. To solve the problem, an annular baffle is used to replace the press ring 14.

Referring to FIG. 2A, an annular baffle 20 includes an annular main body 201, an outer ring 202 and an inner ring 203. Referring to FIG. 2B, a lens assembly 30 includes a lens 31 and an annular baffle 20 which is bonded to an image-side surface 312 by UV adhesive 33. When the UV adhesive 33 is solidified, it covers a portion of the annular main body 201 adjacent to the outer ring 202 and a lens rear end 313 of the lens 31, whereby the annular baffle 20 is bonded to the image-side surface 312. However, when the UV adhesive is applied to the annular baffle 20, the DV adhesive tends to seep into a space between the image-side surface 312 and the annular baffle 20 and receives no UV rays for solidification. The seeped DV adhesive may contaminate the image-side surface 312 and thus influence optical quality of the lens assembly 30.

### BRIEF SUMMARY OF THE INVENTION

The invention provides a lens assembly and a baffle capable of effectively preventing entry of strong light into the lens assembly and avoiding the flare problem. The baffle in accordance with an exemplary embodiment of the invention includes an annular body comprising a annular main body, an outer ring and an inner ring, wherein the annular main body is disposed between the outer ring and the inner ring and connects the outer ring and the inner ring; and a plurality of protrusion protruding from the outer ring.

In the exemplary embodiment, the protrusions are equally spaced from each other.

In the exemplary embodiment, a difference between a diameter of the outer ring and a diameter of the inner ring is greater than or equal to 0.7 mm; a difference between a diameter of the protrusions and the diameter of the outer ring is greater than or equal to 0.5 mm.

In the exemplary embodiment, each of the protrusions comprises two lateral sides which are curved and have a curvature greater than or equal to 0.25 mm; the protrusions are spaced by an angular distance of 30° to 60°.

The invention further provides a lens assembly. The lens assembly in accordance with an exemplary embodiment of the invention includes a first lens and a baffle, all of which are arranged in sequence from the object side to the image side. The first lens includes a first surface facing an object side and a second surface facing an image side.

In the exemplary embodiment, the baffle is bonded to the second surface by adhesive.

In the exemplary embodiment, the first lens further includes a first lens rear end contacting the protrusions of the baffle.

In the exemplary embodiment, the lens assembly further includes a second lens which is disposed between the first lens and the baffle and includes a third surface facing the object side and a fourth surface facing the image side.

In the exemplary embodiment, the baffle is bonded to the fourth surface by adhesive.

In the exemplary embodiment, the second lens further includes a second lens rear end contacting the protrusions of the baffle.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a cross section of a conventional optical lens having a press ring; and

FIG. 2A depicts a conventional annular baffle;

FIG. 2B is a cross section of an optical lens having an conventional annular baffle;

FIG. 3 is a schematic view of a baffle in accordance with a first embodiment of the invention;

FIG. 4 is a cross section of a lens assembly in accordance with the first embodiment of the invention;

FIG. 5A is a schematic view of flare generated by a light entering a conventional optical lens at an angle of 18° with respect to an optical axis of the optical lens;

FIG. 5B is a schematic view of flare generated by a light entering a lens assembly of the first embodiment at an angle of 18° with respect to an optical axis of the lens assembly;

FIG. 6A is a schematic view of flare generated by a light entering a conventional optical lens at an angle of 22° with respect to an optical axis of the optical lens;

FIG. 6B is a schematic view of flare generated by a light entering a lens assembly of the first embodiment at an angle of 22° with respect to an optical axis of the lens assembly;

FIG. 7A is a schematic view of flare generated by a light entering a conventional optical lens at an angle of 26° with respect to an optical axis of the optical lens;

FIG. 7B is a schematic view of flare generated by a light entering a lens assembly of the first embodiment at an angle of 26° with respect to an optical axis of the lens assembly; and

FIG. 8 is a schematic view of a baffle in accordance with a second embodiment of the invention.

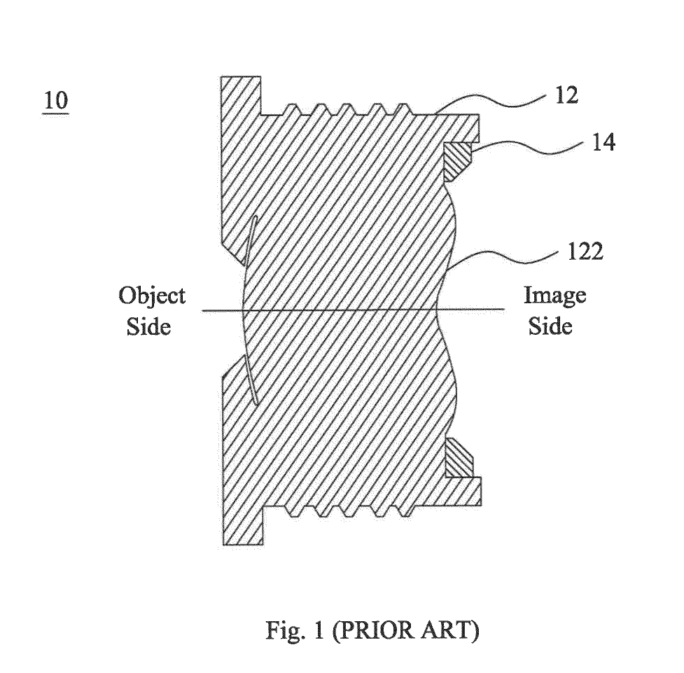

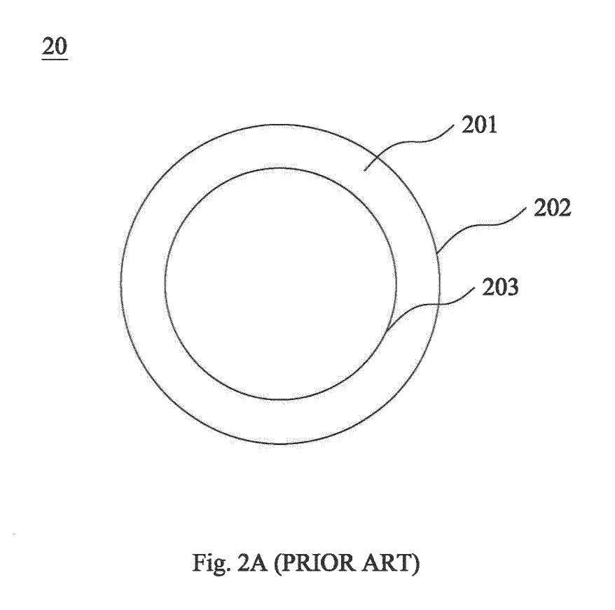

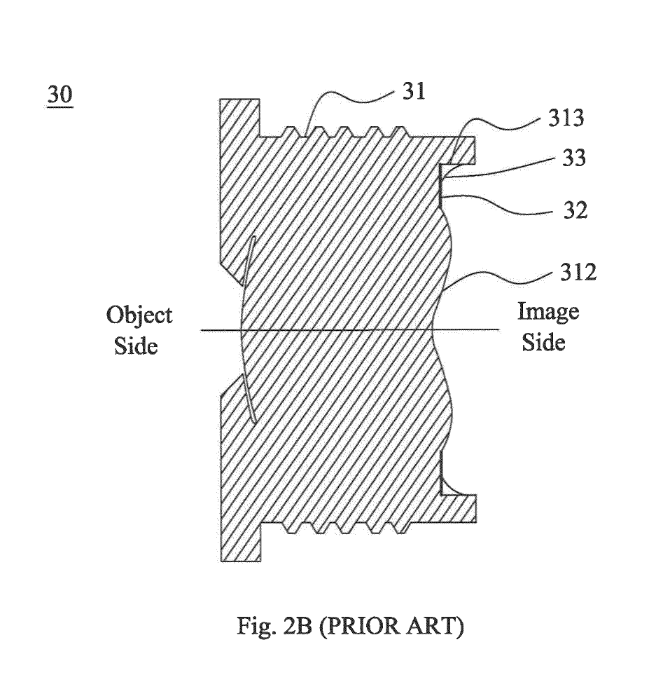

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

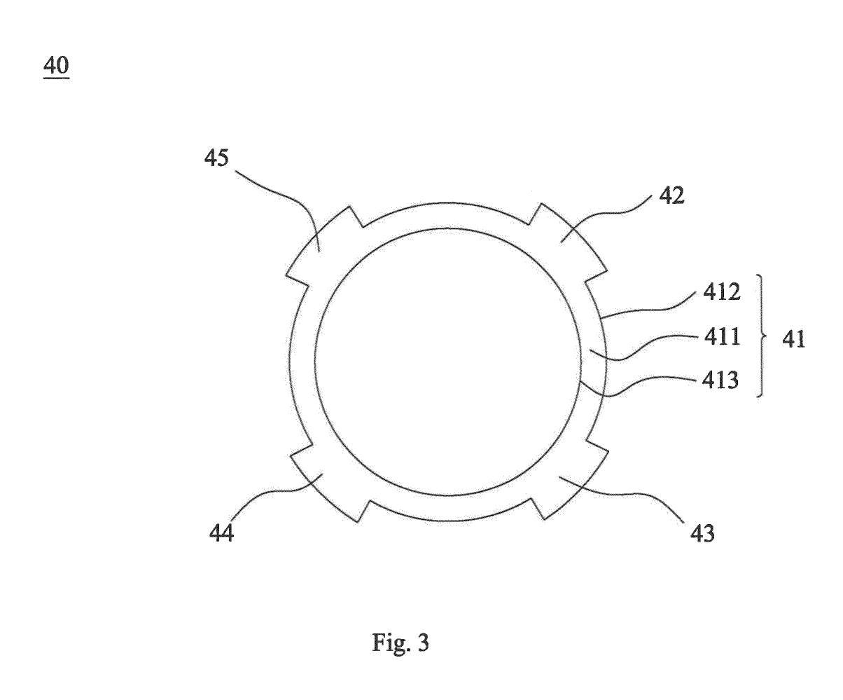

Referring to FIG. 3, a baffle 40 includes an annular body 41 and four protrusions 42, 43, 44 and 45. The annular body 41 includes an annular main body 411, an outer ring 412 and an inner ring 413. The protrusions 42, 43, 44 and 45 protrude from the outer ring 412 and are spaced equally.

Referring to FIG. 4, a lens assembly 50 includes a first lens 51 and a baffle 40. The first lens 51 includes a first surface 511, a second surface 512 and a lens rear end 513. The protrusions 42, 43, 44 and 45 of the baffle 40 contact the lens rear end 513. The baffle 40 is bonded to an outer edge 5121. of the second surface 512 by UV adhesive 53. The UV adhesive 53 is applied to a portion of the annular main body 411 near the outer ring 412 and the corner between the outer edge 5121 of the second surface 512 and the lens rear end 513. Because the UV adhesive is solidified by exposing to UV rays, no UV adhesive 53 seeps into the space between the baffle 40 and the outer edge 5121 of the second surface 512. All UV adhesive 53 is solidified without contaminating the second surface 512. The solidified UV adhesive 53 is applied to the portion of the annular main body 411 near the outer ring 412 and the corner between the outer edge 5121 of the second surface 512 and the lens rear end 513, whereby the baffle 40 is bonded to the second surface 512 to prevent entry of strong light into the lens assembly 50 and avoid the flare problem.

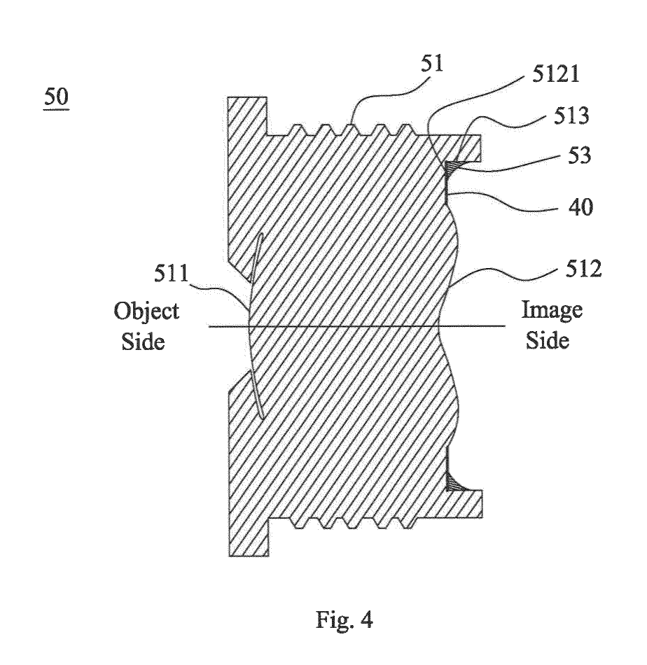

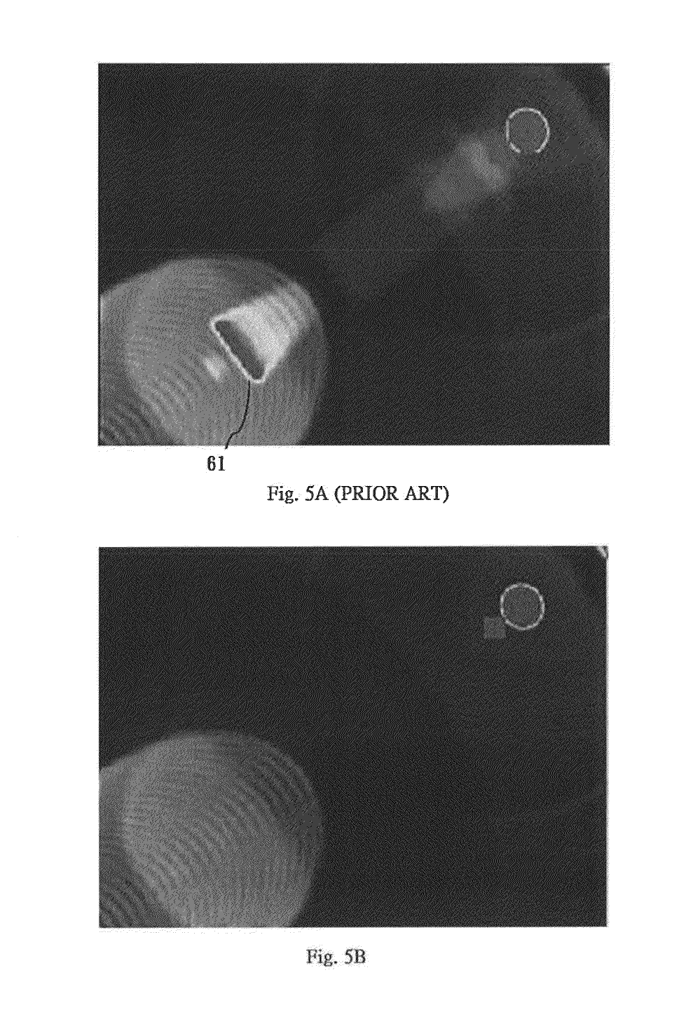

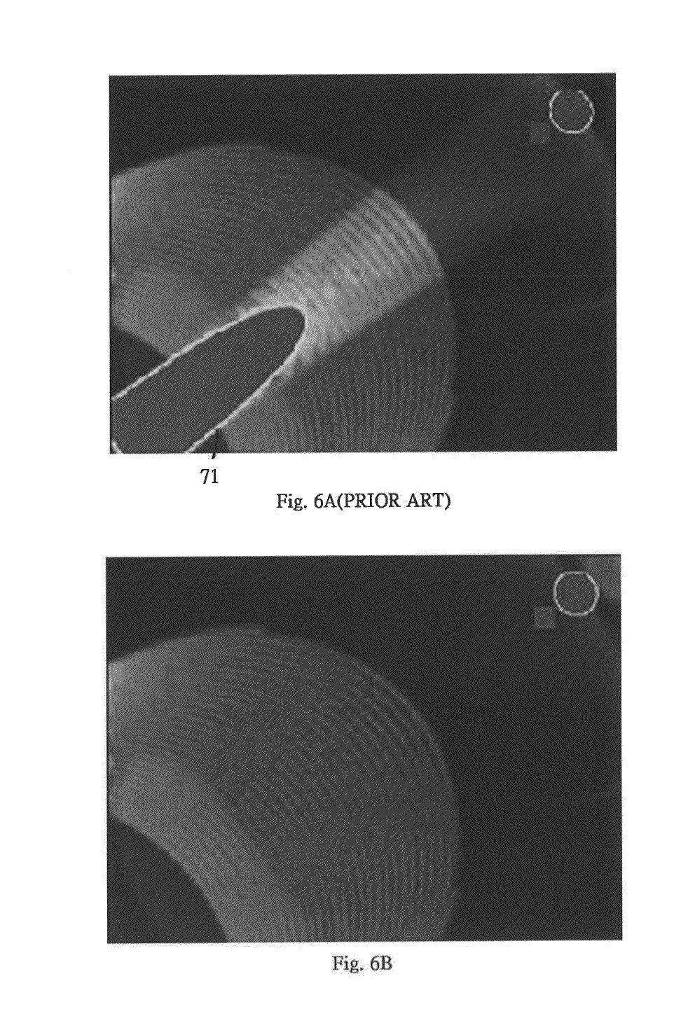

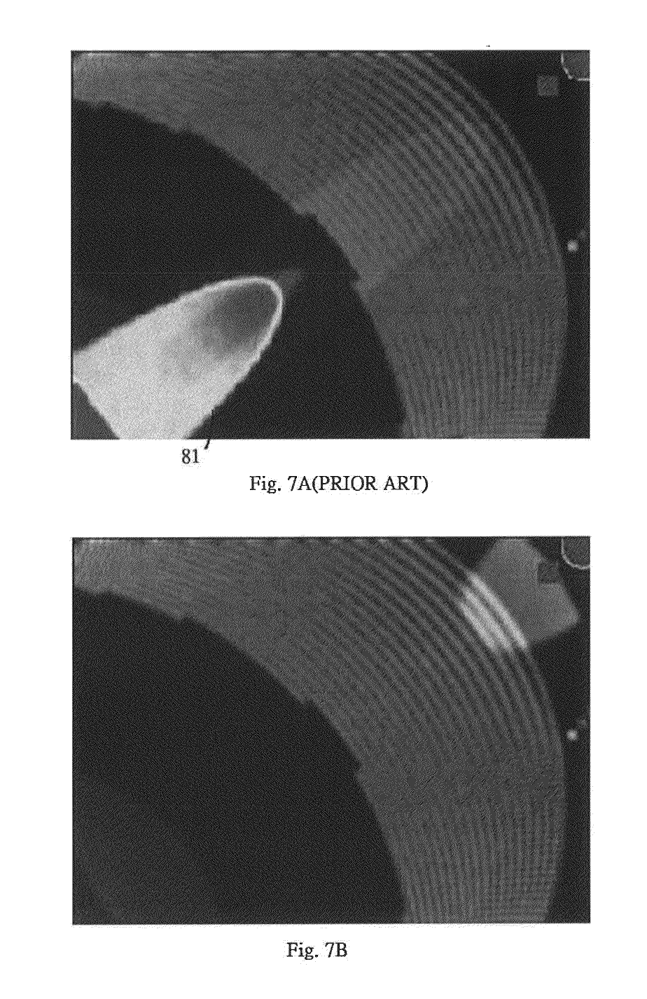

Referring to FIGS. 5A, 5B, 6A, 6B, 7A and 7B, FIGS. 5A, 6A and 7A depict flare generated by a light entering the conventional optical lens at an angle of 18°, 22° and 26° with respect to an optical axis of the optical lens; FIGS. 5B, 6B and 7B depict flare generated by a light entering the lens assembly of the first embodiment at an angle of 18°, 22° and 26° with respect to an optical axis of the lens assembly. It is obvious that flare 61, 71 and 81 occurs at the lower left corner of FIGS. 5A, 6A and 7A. However, no flare occurs in FIGS. 5b, 6b and 7b. Thus, the invention can effectively block entry of strong light into the lens assembly and avoid flare problem that is superior to the prior art,

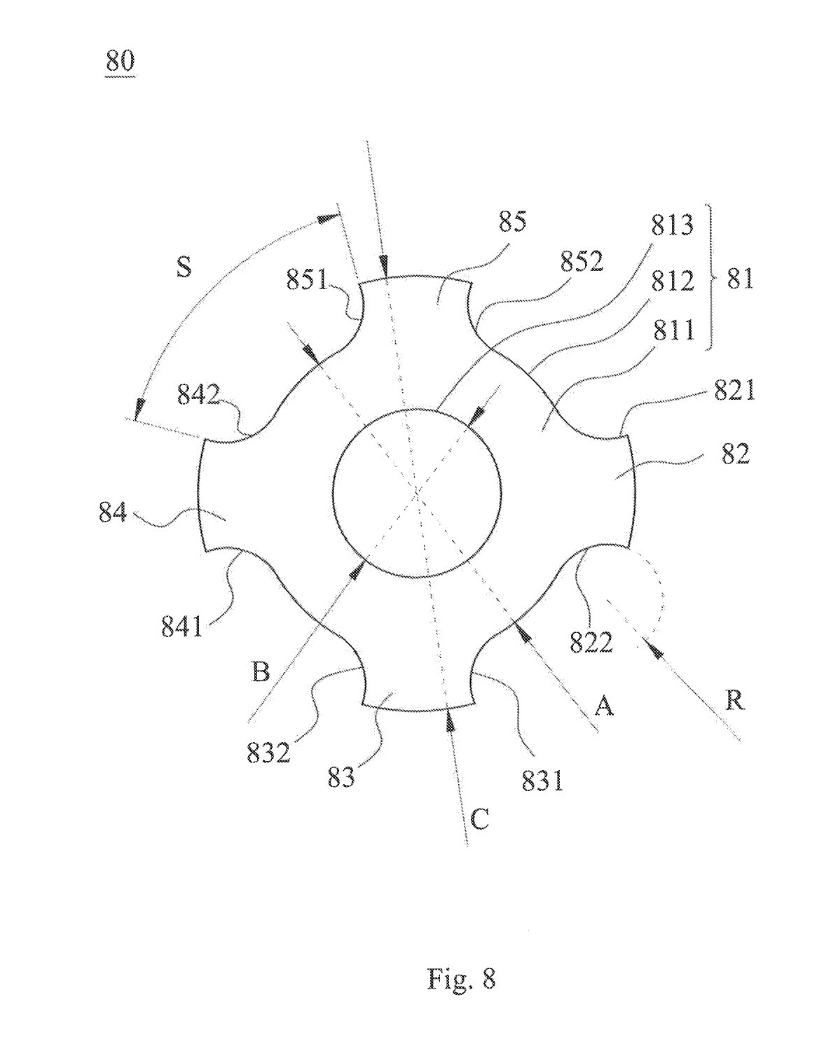

Referring to FIG. 8, a baffle 80 includes an annular body 81 and four protrusions 82, 83, 84 and 85. The annular body 81 includes an annular main body 811, an outer ring 812 and an inner ring 813. The protrusions 82, 83, 84 and 85 protrude from the outer ring 812. Each protrusion has two lateral sides. The lateral sides 821, 822, 831, 832, 841 842, 851 and 852 are curved and have a radius of curvature greater than or equal to 0.25 mm. The adjacent protrusions are spaced by an angular distance from 30° to 60°. The difference between the diameter C of the protrusion and the diameter A of the outer ring 812 is greater than or equal to 0.5 mm. The difference between the diameter A of the outer ring 812 and the diameter B of the inner ring is greater than or equal to 0.7 mm.

In the previous embodiment, the protrusions 42, 43, 44 and 45 are in sector shape, but it is not limited thereto, The protrusions 42, 43, 44 and 45 may be in other shapes.

In the previous embodiment, there are four protrusions 42, 43, 44 and 45, but it is not limited thereto. The number of the protrusions may be other than four (for example 2, 3, 5 or more).

In the previous embodiment, the lens assembly 50 includes one piece of first lens 51, but it is not limited thereto. The lens assembly 50 may includes more than one lens.

In the previous embodiment, the baffle 80 has four protrusions 82, 83, 84 and 85, but it is not limited thereto. The number of the protrusions may be other than four (for example 2, 3, 5 or more).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A baffle, comprising:
an annular body comprising a annular main body, an outer ring and an inner ring, wherein the annular main body is disposed between the outer ring and the inner ring and connects the outer ring and the inner ring; and
a plurality of protrusions protruding from the outer ring.

2. The baffle as claimed in claim 1, wherein the protrusions are equally spaced from each other.

3. The baffle as claimed in claim 1, wherein a difference between a diameter of the outer ring and a diameter of the inner ring is greater than or equal to 0.7 mm; a difference between a diameter of the protrusions and the diameter of the outer ring is greater than or equal to 0.5 mm.

4. The baffle as claimed in claim 1, wherein each of the protrusions comprises two lateral sides which are curved and have a radius of curvature greater than or equal to 0.25 mm; and the protrusions are spaced by an angular distance of 30° to 60°.

5. A lens assembly comprising:
a first lens comprising a first surface facing an object side and a second surface facing an image side; and
a baffle as claimed in claim 1, wherein the first lens and the baffle are arranged in sequence from the object side to the image side along an optical axis.

6. The lens assembly as claimed in claim 5, wherein the baffle is bonded to the second surface by adhesive.

7. The lens assembly as claimed in claim 6, wherein the first lens further comprises a first lens rear end contacting the protrusions of the baffle.

8. The lens assembly as claimed in claim 5 further comprises a second lens disposed between the first lens and the baffle, wherein the second lens comprises a third surface facing the object side and a fourth surface facing the image side.

9. The lens assembly as claimed in claim 8, wherein the baffle is bonded to the fourth surface by adhesive.

10. The lens assembly as claimed in claim 9, wherein the second lens further comprises a second lens rear end contacting the protrusions of the baffle.
